(19) United States
(12) Patent Application Publication
(10) Pub. No.: US 2007/0222744 A1
(43) Pub. Date: Sep. 27, 2007

(54) LIQUID CRYSTAL DISPLAY DEVICE AND DISPLAY CONTROL METHOD

(76) Inventors: Mitsutaka Okita, Hakusan-shi (JP); Kazuhiro Nishiyama, Kanazawa-shi (JP); Daiichi Suzuki, Sendai-shi (JP); Shigesumi Araki, Ishikawa-gun (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/757,120

(22) Filed: Jun. 1, 2007

Related U.S. Application Data
(63) Continuation of application No. PCT/JP05/22113, filed on Dec. 1, 2005.

(30) Foreign Application Priority Data
Dec. 2, 2004 (JP) 2004-350326

(51) Int. Cl. G09G 3/36

(52) U.S. Cl. 345/102

(57) ABSTRACT

A liquid crystal display device includes a display panel having liquid crystal pixels, and a backlight which illuminates the display panel. In particular, this liquid crystal display device further includes a light source driving unit which turns on and off the backlight at a predetermined duty ratio every frame period for update of a video signal, and a panel driving unit which allows each of the liquid crystal pixels to hold a variable pixel voltage that depends on the video signal for a gradation display period longer than a turn-on period of the backlight and which allows each of the liquid crystal pixels to hold a fixed pixel voltage that does not depend on this video signal for a non-gradation display period shorter than a turn-off period of the backlight.

### CROSS-REFERENCE TO RELATED APPLICATIONS

This is a Continuation Application of PCT Application No. PCT/JP2005/022113, filed Dec. 1, 2005, which was published under PCT Article 21(2) in Japanese.

This application is based upon and claims the benefit of priority from prior Japanese Patent Application No. 2004-350326, filed Dec. 2, 2004, the entire contents of which are incorporated herein by reference.

### BACKGROUND OF THE INVENTION

1. Field of the Invention

The present invention relates to a liquid crystal display device and a display control method in which, for example, one frame period is divided into a gradation display period and a non-gradation display period, variable-gradation display is performed in response to a video signal in the gradation display period, and display of a fixed gradation such as black or an intermediate gradation is performed in the non-gradation display period.

2. Description of the Related Art

A flat-panel display device represented by a liquid crystal display device is broadly utilized as a display device of a computer, a car navigation system, a television receiver and the like. In general, the liquid crystal display device has a liquid crystal display panel including a matrix array of liquid crystal pixels; a backlight which illuminates this liquid crystal display panel; and a display control circuit which controls the display panel and the backlight. The liquid crystal display panel has a structure in which a liquid crystal layer is held between an array substrate and a counter-substrate.

The array substrate has a plurality of pixel electrodes arrayed substantially in a matrix form; a plurality of gate lines arranged along the rows of pixel electrodes; a plurality of source lines arranged along the columns of pixel electrodes; and a plurality of switching elements arranged near intersections between the gate lines and the source lines. Each switching element is constituted of, for example, a thin film transistor (TFT), and turns on to apply a potential of one source line to one pixel electrode when one gate line is driven. The counter-substrate is provided with a common electrode that faces the pixel electrodes arrayed on the array substrate. A pair of the pixel electrode and the common electrode constitute a pixel together with a pixel region which is a part of the liquid crystal layer located between these electrodes. In the pixel region, the alignment of liquid crystal molecules is controlled by an electric field between the pixel electrode and the common electrode. The display control circuit includes a gate driver which drives the gate lines; a source driver which drives the source lines; a controller circuit which controls the gate driver, source driver, and backlight, for example.

In a case where the liquid crystal display device is for use in a television receiver which mainly displays a moving image, there is investigated using of the liquid crystal display panel of an OCB mode in which liquid crystal molecules indicate a satisfactory response (see Jpn. Pat. Appln. KOKAI Publication No. 2002-202491). In the liquid crystal display panel, the liquid crystal molecules are aligned in a splay alignment before supply of power. This splay alignment is a state where the liquid crystal molecules are laid down, and obtained by alignment films which are disposed on the pixel electrode and the common electrode and rubbed in parallel with each other. The liquid crystal display panel performs an initializing process upon supply of power. In this process, a relatively intense electric field is applied to the liquid crystal molecules to transition the splay alignment to a bend alignment. A display operation is performed after the initializing process.

The reason why the liquid crystal molecules are aligned in the splay alignment before supply of power is that the splay alignment is more stable than the bend alignment in terms of energy in a voltage-non-applied state of a liquid crystal driving voltage. As a characteristic of the liquid crystal molecules, the bend alignment tends to be inverse-transitioned to the splay alignment in a state where no voltage is applied or a state where a voltage lower than a level at which the energy of splay alignment is balanced with the energy of bend alignment is applied, continues for a long time. The viewing angle characteristic of the splay alignment significantly differs from that of the bend alignment. Thus, a normal display is not attained in this splay alignment.

In a conventional driving method that prevents the inverse transition from the bend alignment to the splay alignment, a high voltage is applied to the liquid crystal molecules in a part of a frame period for a display of a 1-frame image, for example. This high voltage corresponds to a pixel voltage for a black display in an OCB-mode liquid crystal display panel, which is a normally-white type, so this driving method is called “black insertion driving”.

In the meantime, since the liquid crystal display panel is a hold-type display device that holds a display state until updating of image data, it is difficult to smoothly display the motion of an object, owing to the effect of retinal persistence occurring on a viewer's vision in moving-image display. In the black insertion driving, the retinal persistence is cleared by a discrete pseudo-impulse response waveform of pixel luminance. Thus, the black insertion driving is effective in improving the moving-image viewability, which lowers due to the viewer's vision. A black insertion ratio is usually set to about 20% as a ratio of a black insertion period (non-gradation display period) in one frame period in order to prevent the above inverse transition. However, if this black insertion ratio is increased to about 50%, it is possible to obtain the moving-image viewability without any sense of difference in the same manner as in a CRT.

Even in a case where white display is performed in response to a video signal in a gradation display period, when the black display is performed in a black insertion period, the luminance of the white display drops as an average value in one frame period, and further drops owing to the increase of the black insertion ratio. In addition, since the conventional black insertion driving is performed by constantly turning on the backlight, this backlight consumes power even in the black insertion period, and further inhibits a black display state from being brought to a complete black state having a luminance of zero. When contrast is actually measured, it is confirmed that the contrast indicates 500 at a black insertion ratio of 20% and that the ratio largely drops to 285 at a black insertion ratio of 50%.

Usually, the backlight is constituted of a single cold cathode tube constituting a backlight source (illuminative light source). For example, when the first half and the last half of one frame period are set to the gradation display period and the black insertion period, respectively, and blinking driving is performed to turn on the backlight source in the gradation display period and turn off the source in the black insertion period, power consumption can be reduced to improve the moving-image viewability. Accordingly, the contrast can also be improved to a certain degree, but a satisfactory contrast has not been obtained owing to an influence of a difference between an optical response of the liquid crystal pixel and an optical response of the backlight or an influence occurring in a case where a plurality of backlight sources are arranged as the backlight and allowed to blink with different phases.

### BRIEF SUMMARY OF THE INVENTION

An object of the present invention is to provide a liquid crystal display device and a display control method which can prevent a drop of contrast accompanying improvement of moving-image viewability.

According to a first aspect of the present invention, there is provided a liquid crystal display device comprising: a display panel having a plurality of liquid crystal pixels; an illuminative light source unit which illuminates the display panel; a light source driving unit which turns on and off the illuminative light source unit at a predetermined duty ratio every frame period for update of the video signal; and a panel driving unit which allows each of the liquid crystal pixels to hold a variable pixel voltage that depends on the video signal for a gradation display period longer than a turn-on period of the illuminative light source unit and to hold a fixed pixel voltage that does not depend on the video signal for a non-gradation display period shorter than a turn-off period of the illuminative light source unit.

According to a second aspect of the present invention, there is provided a method of controlling display of a liquid crystal display device which includes a display panel having a plurality of liquid crystal pixels, and an illuminative light source unit which illuminates the display panel, the method comprising: turning on and off the illuminative light source unit at a predetermined duty ratio every frame period for update of a video signal; and allowing each of the liquid crystal pixels to hold a variable pixel voltage that depends on the video signal for a gradation display period longer than a turn-on period of the illuminative light source unit and to hold a fixed pixel voltage that does not depend on the video signal for a non-gradation display period shorter than a turn-off period of the illuminative light source unit.

In the liquid crystal display device and the display control method, the variable pixel voltage that depends on the video signal is held by each of the liquid crystal pixels for the gradation display period which is longer than the turn-on period (i.e., a driving period to turn on light) of the illuminative light source unit, and the fixed pixel voltage that does not depend on the video signal is held by each of the liquid crystal pixels for the non-gradation display period which is shorter than the turn-off period (i.e., a driving stop period to turn off light, or a slightly driving period to bring about a substantial light-off state) of the illuminative light source unit. That is, when the minimum gradation luminance level of the liquid crystal pixel is lowered by reducing the duty ratio of the illuminative light source unit, the maximum gradation luminance level of the liquid crystal pixel might be lowered. However, since the non-gradation display period is shortened, the gradation display period continues even after the illuminative light source unit turns off. Therefore, there is effectively utilized afterglow emitted from the illuminative light source unit for a while after the illuminative light source unit turns off, and the luminance level of the liquid crystal pixel with respect to the maximum gradation can be raised. In a case where the illuminative light source unit is constituted of a plurality of light sources, the luminance level of the liquid crystal pixel with respect to the maximum gradation can further be raised by effectively utilizing the light from the adjacent light source. Therefore, there is compensation for an influence due to a difference between an optical response of the liquid crystal pixel and an optical response of the illuminative light source or an influence occurring in a case where the illuminative light sources are allowed to blink with different phases, and it is possible to prevent a drop of contrast accompanying improvement of moving-image viewability.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram schematically showing the circuit configuration of a liquid crystal display device in one embodiment of the present invention;

FIG. 2 is a diagram showing a sectional structure of a liquid crystal display panel shown in FIG. 1;

FIG. 3 is a time chart showing an operation in a case where black insertion driving is performed at a vertical scanning speed of 1.5× in the liquid crystal display device shown in FIG. 1;

FIG. 4 is a diagram showing a relation between a backlight and the display panel shown in FIG. 1;

FIG. 5 is a diagram showing, in more detail, the circuit configuration of an inverter control circuit, a backlight driver and a backlight circuit shown in FIG. 1; and

FIG. 6 is a time chart showing an operation of the inverter control circuit shown in FIG. 5.

### DETAILED DESCRIPTION OF THE INVENTION

There will be described hereinafter a liquid crystal display device in one embodiment of the present invention with reference to the accompanying drawings.

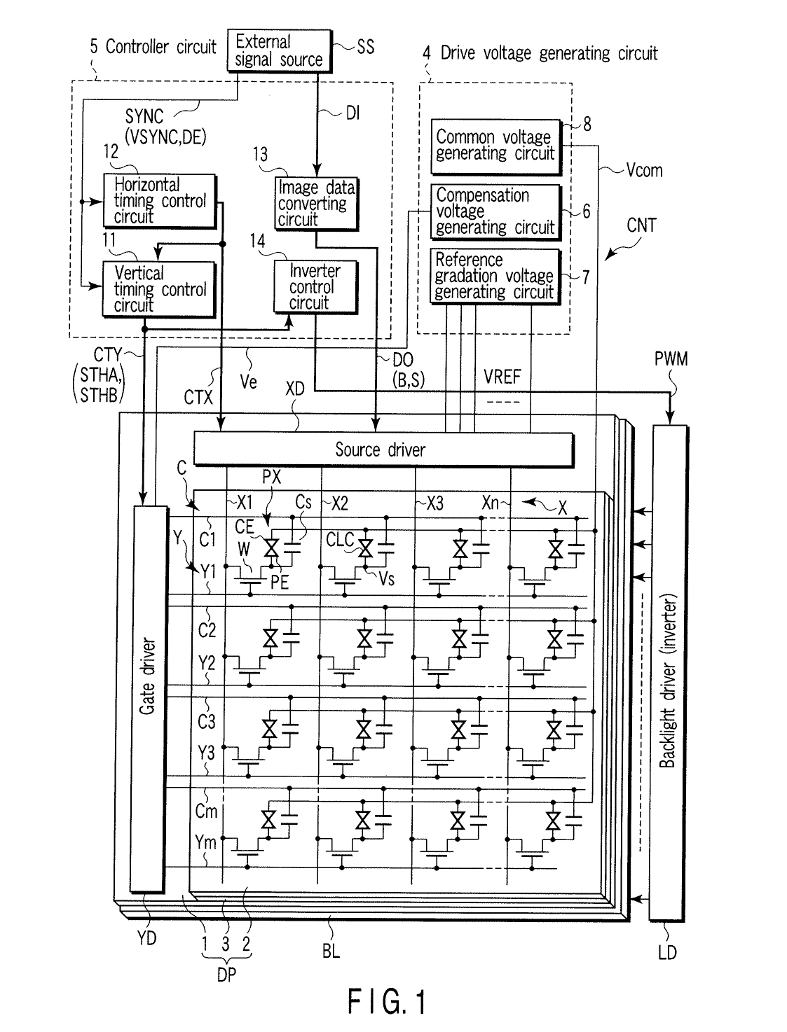

FIG. 1 schematically shows the circuit configuration of this liquid crystal display device. The liquid crystal display device includes a liquid crystal display panel DP; a backlight BL which illuminates the display panel DP; and a display control circuit CNT which controls the display panel DP and the backlight BL. The liquid crystal display panel DP has a structure in which a liquid crystal layer 3 is held between an array substrate 1 and a counter-substrate 2 as a pair of electrode substrates. The liquid crystal layer 3 includes, as a liquid crystal material, liquid crystal molecules which are transitioned in advance from a splay alignment to a bend alignment for, for example, a normally white display operation, and are prevented from inverse-transition from the bend alignment to the splay alignment by a periodically applied black-display voltage. The display control circuit CNT controls transmittance of the liquid crystal display panel DP by a liquid crystal driving voltage applied to the liquid crystal layer 3 from the array substrate 1 and the counter-substrate 2. The transition from the splay alignment to the bend alignment is obtained by applying a comparatively large electric field to the liquid crystal molecules in predetermined initialization performed by the display control circuit CNT upon supply of power.

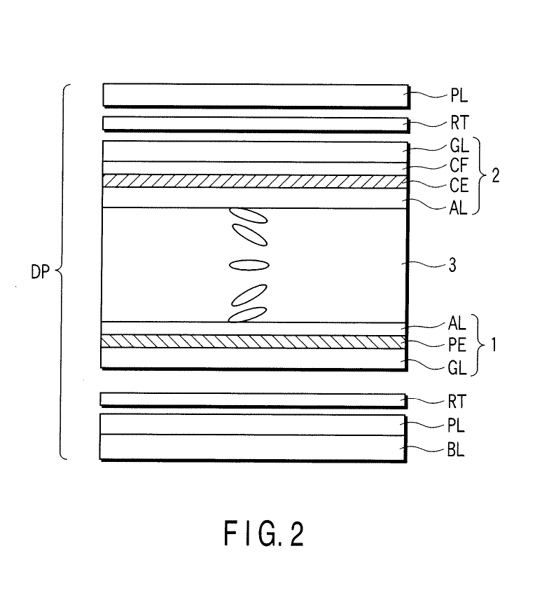

FIG. 2 shows in detail a sectional structure of the liquid crystal display panel DP. The array substrate 1 includes a transparent insulating substrate GL formed of a glass plate or the like; a plurality of pixel electrodes PE formed on this transparent insulating substrate GL; and an alignment film AL formed on these pixel electrodes PE. The counter-substrate 2 includes a transparent insulating substrate GL formed of a glass plate or the like; a color filter layer CF formed on this transparent insulating substrate GL; a common electrode CE formed on this color filter layer CF; and an alignment film AL formed on this common electrode CE. The liquid crystal layer 3 is obtained by filling, with the liquid crystal material, a gap between the counter-substrate 2 and the array substrate 1. The color filter layer CF includes a red colored layer for red pixels, a green colored layer for green pixels, a blue colored layer for blue pixels, and a black colored (shielding) layer for a black matrix. In FIG. 2, liquid crystal molecules 19 are aligned in the splay alignment. The liquid crystal display panel DP includes a pair of retardation plates RT disposed outside the array substrate 1 and the counter-substrate 2; a pair of polarization plates PL disposed outside these retardation plates RT; and a backlight BL provided as a light source outside the polarization plate PL on an array substrate 1. The alignment film AL on the array substrate 1 and the alignment film AL on a counter-substrate 2 are rubbed in parallel with each other. Accordingly, a pre-tilt angle of the liquid crystal molecule is set to about 10°.

In the array substrate 1, the pixel electrodes PE are arranged substantially in a matrix form on the transparent insulating substrate GL. A plurality of gate lines Y (Y1 to Ym) are arranged along the rows of pixel electrodes PE, and a plurality of source lines X (X1 to Xn) are arranged along the columns of pixel electrodes PE. A plurality of pixel switching elements W are arranged near intersections between these gate lines Y and the source lines X. For example, each pixel switching element W is formed of a thin film transistor having a gate connected to a gate line Y, and a source-drain path connected between a source line X and a pixel electrode PE, and is made conductive between the associated source line X and the associated pixel electrode PE when it is driven via the associated gate line Y.

Each pixel electrode PE and the common electrode CE are formed of a transparent electrode material such as ITO, are covered with the alignment films AL, respectively, and constitute a liquid crystal pixel PX together with a pixel region which is a part of the liquid crystal layer 3 whose liquid crystal molecule alignment is controlled according to the electric field from the pixel electrode PE and the common electrode CE.

Each of the liquid crystal pixels PX has a liquid crystal capacitance CLC between the pixel electrode PE and the common electrode CE. Each of storage capacitance lines C1 to Cm is capacitively coupled to the pixel electrodes PE of the liquid crystal pixel PX of a corresponding row so as to constitute storage capacitances Cs. The storage capacitance Cs has a sufficiently large capacitance with respect to a parasitic capacitance of the pixel switching element W.

The display control circuit CNT includes a gate driver YD which successively drives the gate lines Y1 to Ym to turn on the pixel switching elements W in units of one row; a source driver XD which outputs pixel voltages Vs to the source lines X1 to Xn while the switching elements W of each row is driven via the associated gate line Y and made conductive; a backlight driver LD which drives the backlight BL; a drive voltage generating circuit 4 which generates voltages for driving the display panel DP; and a controller circuit 5 which controls the gate driver YD, the source driver XD and the backlight driver (inverter) LD.

The drive voltage generating circuit 4 includes a compensation voltage generating circuit 6 which generates a compensation voltage Ve to be applied to the storage capacitance lines C via the gate driver YD; a reference gradation voltage generating circuit 7 which generates the predetermined number of gradation reference voltages VREF for use by the source driver XD; and a common voltage generating circuit 8 which generates a common voltage Vcom to be applied to a common electrode CE. The controller circuit 5 includes a vertical timing control circuit 11 which generates a control signal CTY for the gate driver YD based on a sync signal SYNC (VSYNC, DE) input from an external signal source SS; a horizontal timing control circuit 12 which generates a control signal CTX with respect to the source driver XD based on the sync signal SYNC (VSYNC, DE) input from the external signal source SS; an image data converting circuit 13 which performs, for example, double speed black inserting conversion on image data input for the pixels PX from the external signal source SS; and an inverter control circuit 14 which controls the backlight driver (inverter) LD based on a control signal CTX output from the vertical timing control circuit 11. The image data includes items of pixel data DI for the liquid crystal pixels PX, and is updated every frame period (vertical scanning period V). The control signal CTY is supplied to the gate driver YD, and the control signal CTX is supplied to the source driver XD together with pixel data DO obtained as a conversion result from the image data converting circuit 13. The control signal CTY is used in allowing the gate driver YD to sequentially drive the gate lines Y as described above. The control signal CTX is used in allowing the source driver XD to perform an operation of assigning, to the source lines X, the items of pixel data DO obtained and output in series for the liquid crystal pixels PX for one row as the conversion result of the image data converting circuit 13, and designating the output polarities thereof.

The gate driver YD and the source driver XD are constituted using, for example, a shift register circuit in order to select the gate lines Y and the source lines X, respectively. In this case, the control signal CTY includes a first start signal (gradation display start signal) STHA that controls a gradation display start timing; a second start signal (black insertion start signal) STHB that controls a black insertion start timing; clock signals that cause the start signals STHA and STHB to be shifted in the shift register circuit; an output enable signals which control outputs of driving signals to every predetermined number of the gate lines Y1 to Ym which are selected sequentially or simultaneously according to the positions of the start signals STHA and STHB held in the shift register circuit. On the other hand, the control signal CTX includes a start signal that controls a start timing of capturing pixel data items for one row; a clock signal that causes the start signal to be shifted in the shift register circuit; a load signal that controls a parallel output timing of outputting the pixel data DO for one row captured for the source lines X1 to Xn selected one by one according to the position of the start signal held in the shift register circuit; a polarity signal that controls the signal polarities of the pixel voltages Vs corresponding to the pixel data items, for example.

The gate driver YD sequentially selects the gate lines Y1 to Ym for the gradation display and black insertion in one frame period under the control of the control signal CTY, and supplies, to the selected gate line Y, an on-voltage as a driving signal that turns on the pixel switching elements W of each row for one horizontal scanning period H. In a case where the image data converting circuit 13 performs the double speed black inserting conversion, the input pixel data items DI for one row are converted into black-insertion fixed pixel data items B for one row and gradation-display variable pixel data items S for one row as the output pixel data items DO every 1H. The variable pixel data item S for gradation display indicates a gradation value equal to that of the pixel data DI, and the fixed pixel data item B for black insertion indicates a gradation value of black display. The black-insertion fixed pixel data items B for one row and the gradation-display variable pixel data items S for one row are output in series from the image data converting circuit 13 in an H/2 period. The source driver XD converts these pixel data items B and S into the pixel voltages Vs, respectively, with reference to the predetermined number of the gradation reference voltages VREF supplied from the above-described reference gradation voltage generating circuit 7, and outputs the voltages in parallel to the source lines X1 to Xn.

The pixel voltage Vs is a voltage applied to the pixel electrode PE, with the common voltage Vcom of the common electrode CE used as a reference, and the polarity of the pixel voltage is inverted with respect to the common voltage Vcom to perform frame-inversion driving and line-inversion driving, for example. In a case where the black insertion driving is performed at the double vertical scanning speed, the polarity of the pixel voltage is inverted with respect to the common voltage Vcom to perform the line-inversion and frame-inversion driving (1H1V inversion driving), for example. When the pixel switching elements W of one row become non-conductive, the compensation voltage Ve is applied via the gate driver YD to a storage capacitance line C corresponding to the gate line Y which is connected to the pixel switching elements W, so as to compensate for fluctuations of the pixel voltages Vs that occur in the pixels PX of one row due to the parasitic capacitances of these pixel switching elements W.

When the gate driver YD drives, for example, the gate line Y1 by the on-voltage to turn on all of the pixel switching elements W connected to this gate line Y1, the pixel voltages Vs of the source lines X1 to Xn are supplied to one ends of the associated pixel electrodes PE and storage capacitances Cs via the pixel switching elements W. The gate driver YD outputs the compensation voltage Ve from the compensation voltage generating circuit 6 to the storage capacitance line C1 corresponding to this gate line Y1, and outputs to the gate line Y1 an off-voltage to turn off the pixel switching elements W immediately after keeping all of the pixel switching elements W connected to the gate line Y1 conductive for one horizontal scanning period. When these pixel switching elements W are turned off, the compensation voltage Ve reduces electric charges to be extracted from the pixel electrodes PE by the parasitic capacitances of these elements, to substantially cancel the substantial fluctuations of the pixel voltage Vs, that is, a field-through voltage ΔVp.

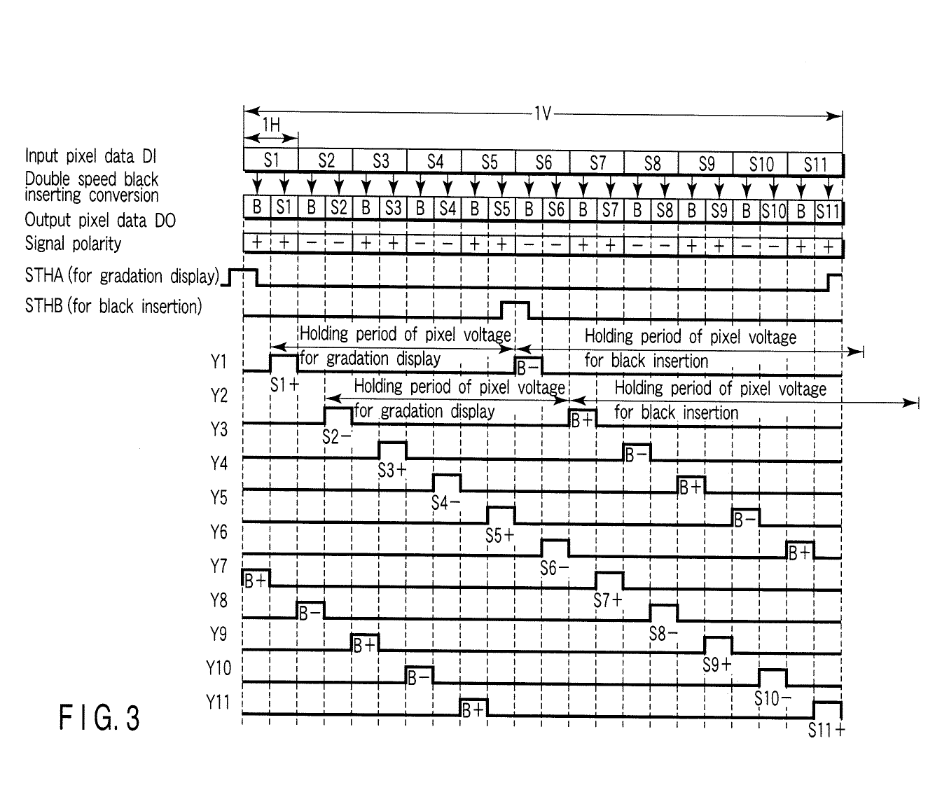

Here, there will be described an operation of the liquid crystal display device shown in FIG. 1 with reference to FIG. 3. In FIG. 3, B denotes black-insertion fixed pixel data which is common to the pixels PX of each row, and S1, S2, S3, . . . denote gradation-display variable pixel data for the pixels PX of a first row, a second row, a third row, . . . . Moreover, + and − denote signal polarities at a time when each of the pixel data B, S1, S2, S3, . . . is converted to the pixel voltage Vs and output from the source driver XD.

FIG. 3 shows an operation of the liquid crystal display device in a case where the black insertion driving is performed at the double vertical scanning speed. Here, each of the first start signal STHA and the second start signal STHB is a pulse input into the gate driver YD with a pulse width for the H/2 period. The first start signal STHA is first input, and the second start signal STHB is input behind the first start signal STHA in accordance with a black insertion ratio. The black insertion ratio is a ratio of a holding period of the fixed pixel voltage for black insertion (i.e., the black insertion period, in other words, non-gradation display period) with respect to a holding period of the variable pixel voltage for gradation display (i.e., the gradation display period). Here, it is assumed that the black insertion ratio is a ratio of the black insertion period in one frame period (1V: vertical scanning period).

The gate driver YD shifts the first start signal STHA to select one line from the gate lines Y1 to Ym per horizontal scanning period H and output a driving signal to the selected gate line Y1, Y2, Y3, . . . in the last half of the period 1H. On the other hand, the source driver XD converts each of the gradation-display variable pixel data S1, S2, S3, . . . into the pixel voltages Vs in the last half of the corresponding period 1H, and outputs these voltages in parallel to the source lines X1 to Xn with the polarity inverted every period 1H. The pixel voltages Vs are supplied to the liquid crystal pixels PX of the first row, the second row, the third row, the fourth row . . . while each of the gate lines Y1 to Ym is driven in the last half of the corresponding period 1H.

Moreover, the gate driver YD shifts the second start signal STHB to select one line from the gate lines Y1 to Ym per horizontal scanning period 1H and output a driving signal to the selected gate line Y1, Y2, Y3, . . . in the first half of the period 1H. On the other hand, the source driver XD converts each of the black-insertion fixed pixel data B, B, B, . . . into the pixel voltages Vs in the first half of the corresponding period 1H, and outputs the voltages in parallel to the source lines X1 to Xn with the polarity reversed every period 1H. These pixel voltages Vs are supplied to the liquid crystal pixels PX of the first row, the second row, the third row, . . . while each of the gate lines Y1 to Ym is driven in the first half of the corresponding period 1H. It is to be noted that in FIG. 3, the first start signal STHA and the second start signal STHB are input at a comparatively short interval. In actual, the signals are separately input so that a relation between the holding period of the variable pixel voltage for gradation display and the holding period of the fixed pixel voltage for black insertion is adapted to the black insertion ratio. The black insertion with respect to the pixels PX in the vicinity of the last row continues from a preceding frame as shown in, for example, a left lower part of FIG. 3.

In addition, in a case where the black insertion driving is performed at the 1.5× vertical scanning speed, the image data converting circuit 13 is constituted to perform 1.5×-speed black inserting conversion with respect to the image data input from the external signal source SS. Furthermore, the source driver XD is constituted to output the pixel voltages Vs to the source lines X1 to Xn, the polarities of the pixel voltages being inverted with respect to the common voltage Vcom to perform dual-line-inversion and frame-inversion driving (2H1V inversion driving). In the black insertion 1.5×-speed conversion, the input pixel data items DI for two rows are converted into the black-insertion fixed pixel data items B for one row and the gradation-display variable pixel data items S for two rows, as the output pixel data items DO every period 2H. The variable pixel data item S for gradation display indicates a gradation value equal to that of the pixel data item DI, and the fixed pixel data item B for black insertion indicates a gradation value of black display. Each of the black-insertion fixed pixel data items B for one row and the gradation-display variable pixel data items S for two rows are output in series from the image data converting circuit 13 in a period 2H/3.

In a case where the black insertion driving is performed at the 1.5× vertical scanning speed, the liquid crystal display device operates as follows. In this case, the first start signal STHA is a pulse input into the gate driver YD with a pulse width for a period 2H/3, and the second start signal STHB is a pulse input into the gate driver YD with a pulse width for a period 2H. The second start signal STHB is input behind the first start signal STHA in accordance with the black insertion ratio.

The gate driver YD shifts the first start signal STHA to sequentially select two lines from the gate lines Y1 to Ym per period 2H and output the signal to the selected gate lines Y1, Y2; Y3, Y4; . . . in second and third 2H/3 periods included in the corresponding period 2H. On the other hand, the source driver XD converts each of the gradation-display variable pixel data S1, S2; S3, S4; . . . into the pixel voltages Vs in second and third 2H/3 periods included in the corresponding period 2H, and outputs these voltages in parallel to the source lines X1 to Xn with the polarity inverted every period 2H. These pixel voltages Vs are supplied to the liquid crystal pixels PX of the first row, the second row, the third row, the fourth row . . . while each of the gate lines Y1 to Ym is driven in the second or third 2H/3 period included in the corresponding period 2H.

Moreover, the gate driver YD shifts the second start signal STHB to sequentially select two lines from the gate lines Y1 to Ym per period 2H and output a driving signal to the selected gate lines Y1, Y2; Y3, Y4; . . . in a first 2H/3 period included in the corresponding period 2H. On the other hand, the source driver XD converts each of the black-insertion fixed pixel data B, B, B, . . . into the pixel voltages Vs in the first 2H/3 period included in the corresponding period 2H, and outputs these voltages in parallel to the source lines X1 to Xn with the polarity inverted every period 2H. These pixel voltages Vs are supplied to the liquid crystal pixels PX of the first row, the second row, the third row, the fourth row . . . while each of the gate lines Y1 to Ym is driven in the first 2H/3 period included in the corresponding period 2H.

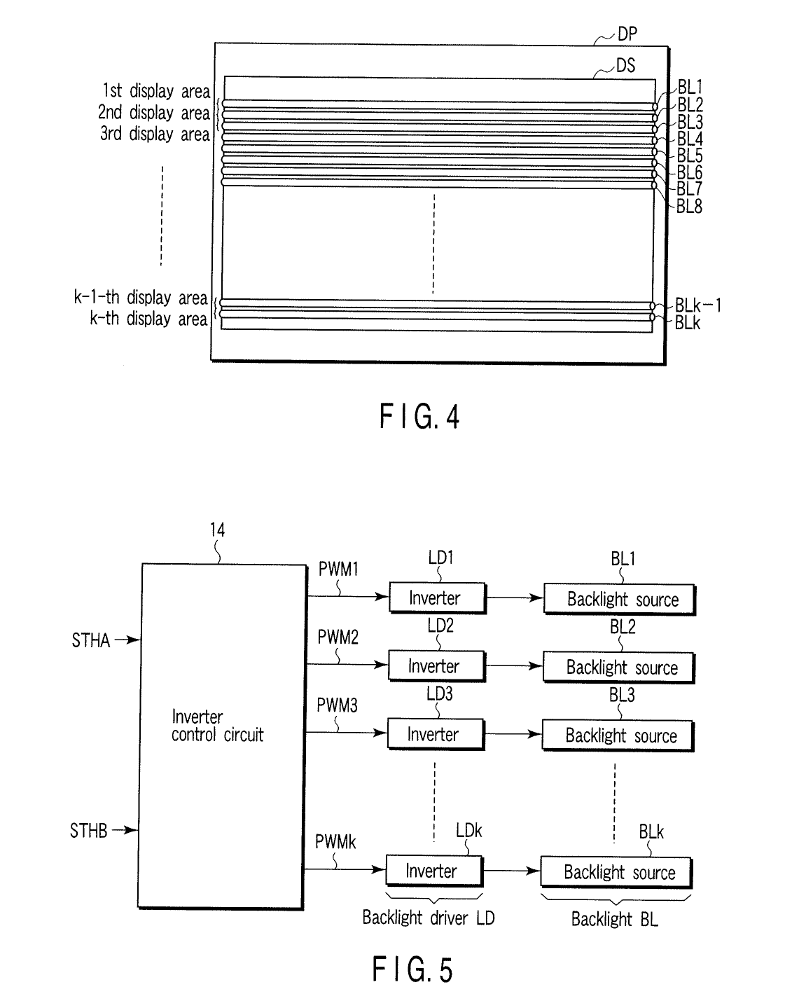

FIG. 4 shows a relation between the backlight BL and the display panel DP shown in FIG. 1. A display screen DS shown in FIG. 4 is made of the liquid crystal pixels PX arranged in a matrix form. The backlight BL includes, for example, k backlight sources BL1 to BLk arranged parallel to the rows of liquid crystal pixel PX at predetermined pitches on the rear surface of the display panel DP. These backlight sources BL1 to BLk mainly illuminate respective display areas which are obtained by equally dividing the screen DS in a vertical direction. Each of the backlight sources BL1 to BKk is formed of a single cold-cathode fluorescent tube. In the actual display panel DP, the screen DS is divided into, for example, 24 display areas, each of which includes the liquid crystal pixels PX for about 25 rows (lines). In this case, each of 24 cold-cathode fluorescent tubes illuminate the liquid crystal pixels PX for about 25 rows (lines) as an illumination target.

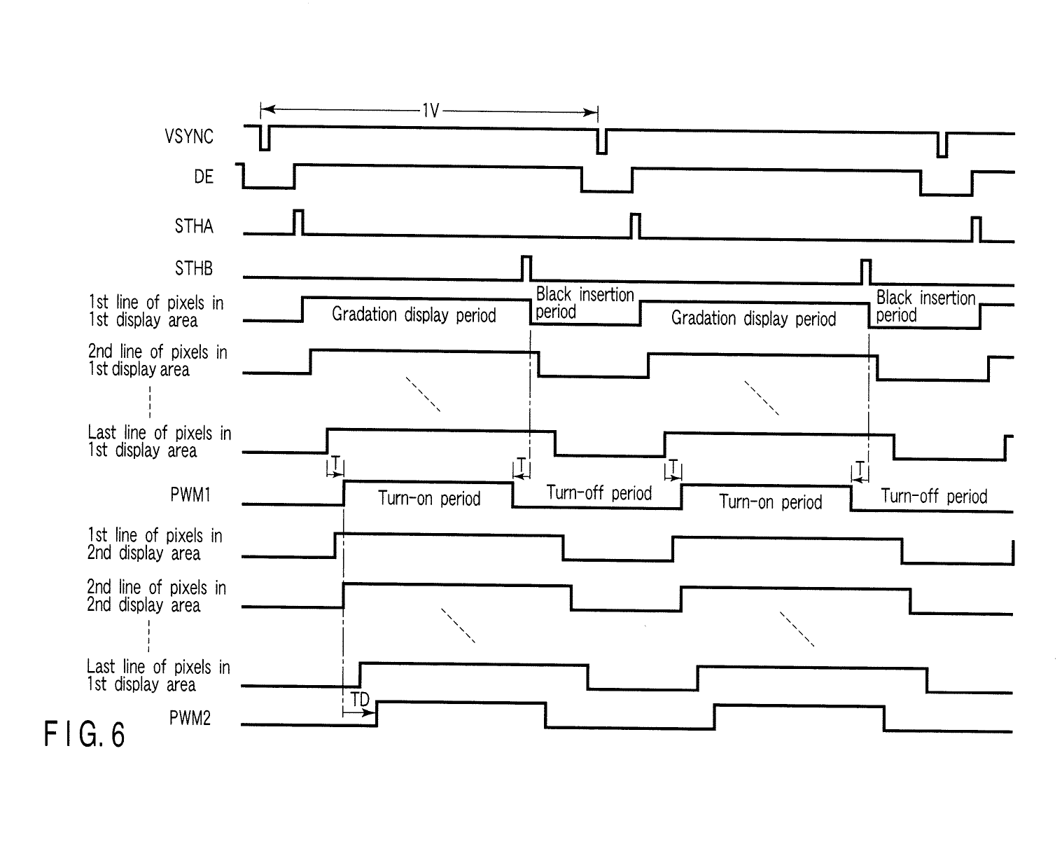

FIG. 5 shows in more detail the circuit configuration of the inverter control circuit 14, the backlight driver LD and the backlight BL shown in FIG. 1. FIG. 6 shows an operation of the inverter control circuit 14. The inverter control circuit 14 controls the backlight driver LD to start an operation of allowing the backlight sources BL1 to BLk to successively blink at a predetermined duty ratio in synchronization with the first start signal STHA. The backlight driver LD includes k inverters LD1 to LDk which generate driving voltages for the backlight sources BL1 to BLk, respectively, and the inverter control circuit 14 generates k pulse width modulation signals PWM (PWM1 to PWMk) shown in FIG. 5 to control these inverters LD1 to LDk, respectively.

The pulse width modulation signal PWM1 is generated using the first and second start signals STHA and STHB in the control signal CTX output from the vertical timing control circuit 11. The first start signal STHA indicates a reference timing to hold the variable pixel voltages for gradation display in the liquid crystal pixels PX of the first row, and the second start signal STHB indicates a reference timing to hold the fixed pixel voltages for black insertion in the liquid crystal pixels PX of the first row. That is, the holding period of the variable pixel voltage for gradation display is substantially equal to a period from a time when the pulse of the first start signal STHA is input until the pulse of the second start signal STHB is input, and the holding period of the fixed pixel voltage for black insertion is substantially equal to a period from a time when the pulse of the second start signal STHB is input until the pulse of the next first start signal STHA is input.

The inverter control circuit 14 is configured to detect, from the first start signal STHA and the second start signal STHB, a black insertion period end timing at which the first line of liquid crystal pixels PX in the first display area start the holding of the variable pixel voltages for gradation display, and a black insertion period start timing at which the first line of liquid crystal pixels PX in the first display area start the holding of the fixed pixel voltages for black insertion. The circuit is further configured to shift the pulse width modulation signal PWM1 to a high level after the black insertion period end timing, and shift the pulse width modulation signal PWM1 to a low level before the black insertion period start timing. The duty ratio of this pulse width modulation signal PWM1 is set to a predetermined value of 50% with respect to a black insertion ratio of 30%.

Specifically, when a period equal to a predetermined period T1 elapses from the black insertion period end timing specified by the pulse of the first start signal STHA, the inverter control circuit 14 raises the pulse width modulation signal PWM1. When a period elapses from the rise of this signal, the period being shorter as much as a predetermined period T2 than the gradation-display variable pixel voltage holding period equal to an interval between the first start signal STHA and the second start signal STHB, the inverter control circuit lowers the pulse width modulation signal PWM1. The predetermined periods T1, T2 are preferably set by taking the response characteristics of the OCB-mode liquid crystal material and the backlight BL into consideration. When the existing response characteristic is used as a reference, each of the predetermined periods T1, T2 is set to be longer than 0 and shorter than about 30% of one frame period, whereby balances of luminance, contrast and response can substantially be optimized. Furthermore, in a case where a light utilization efficiency is focused on in performing the optimization, it is more preferable that each of the predetermined periods T1, T2 is set to a range of 5% to 10%. To measure the elapsed time, a counter to count, for example, clock pulses is disposed, the counting of this clock pulse is started with the transition of the start signal STHA, and the pulse width modulation signal PWM1 may be allowed to transition at an appropriate timing based on this count value. In this case, it is confirmed that the start signal STHB is delayed by the predetermined period T1 from the fall of the pulse width modulation signal PWM1. If there is a deviation, the signal is used in correcting the duty ratio of the pulse width modulation signal PWM1 in the subsequent frame. The pulse width modulation signals PWM2 to PWMk are signals of the same duty ratio obtained by delaying the pulse width modulation signal PWM1, and the signals deviate as much as a phase difference TD shown in FIG. 6 from the pulse width modulation signals PWM1 to PWMk−1, respectively. This phase difference TD is determined in accordance with pitches of the backlight sources BL1 to BLk. The inverters LD1 to LDk convert the pulse width modulation signals PWM1 to PWMk from the inverter control circuit 14 into the driving voltages, and output the converted voltages to the backlight sources BL1 to BLk, respectively. The backlight sources BL1 to BLk turn on at a time when the pulse width modulation signals PWM1 to PWMk indicate high levels, respectively, and the light sources turn off at a time when the pulse width modulation signals PWM1 to PWMk indicate low levels, respectively.

As apparent from FIG. 6, the rise of the pulse width modulation signal PWM1 is delayed by the predetermined period T1 from the black insertion period end timing of the last line of the pixels PX in the first display area, and the fall of the pulse width modulation signal PWM1 advances by the predetermined period T2 from the black insertion period start timing of the last line of the pixels PX in the first display area. The predetermined periods T1, T2 are set so that the backlight source BL1 is not turned on in the black insertion period of the first and subsequent lines of the pixels PX in the second display area which is not the illumination target of the backlight source BL1 but which is adjacent to the first display area and on which illuminative light strikes. After the light source turns on, the backlight source BL1 is turned off before the black insertion period start timing of the pixel PX of the first line of the first display area to emit afterglow. The duty ratio of each of the pulse width modulation signals PWM2 to PWMk coincides with that of the pulse width modulation signal PWM1, and the signals deviate every phase difference TD in which the pitches of the backlight sources BL1 to BLk are reflected. Therefore, the backlight sources BL2 to BLk are driven in the same manner as that of the above backlight source BL1.

In the liquid crystal display device of the present embodiment, each of the backlight sources BL1 to BLk turns on after the black insertion period end timing at which the liquid crystal pixels PX of the illumination target start the holding of the variable pixel voltage, and turns off before the black insertion period start timing at which the liquid crystal pixels PX of the illumination target start the holding of the fixed pixel voltage. That is, since the black insertion period is set to be shorter than a turn-off period of each of the backlight sources BL1 to BLk, it is possible to compensate for an influence of an optical response of each of the backlight sources BL1 to BLk, the optical response being slower than that of the liquid crystal pixel PX, or an influence generated in a case where these backlight sources BL1 to BLk are allowed to blink with different phases. Therefore, it is possible to prevent a drop of contrast accompanying improvement of moving-image viewability.

As a comparative example, as a constitution which allows the backlight sources BL1 to BLk to successively blink, each turn-on period of each of the backlight sources BL1 to BLk at a black insertion ratio of 50% is matched with 50% (duty ratio of 50%) of one frame without providing any predetermined periods T1, T2. In this case, the i-th backlight source BLi and the i+1-th backlight source BLi+1 successively turn on, and successively turn off. The illumination targets of the backlight sources BLi and the backlight source BLi+1 are the i-th display area and the i+1-th display area. Thus, the contrast is better than that in a case where the ratio is 50% of a usual black insertion ratio, but the contrast remains to be insufficient at 390 as compared with a case where the ratio is 20% of the usual black insertion ratio.

According to the configuration of the present embodiment, since the predetermined periods T1, T2 are provided, the black insertion period is set to be shorter than the turn-off period of each of the backlight sources BL1 to BLk. Even in this case, the backlight source BLi and the backlight source BLi+1 successively turn on, and successively turn off. The pixels PX of the i-th display area can continue the gradation display by use of the afterglow emitted from the backlight source BLi after turned off, without wasting any afterglow. Furthermore, since the black insertion period is delayed from the turning-off of the backlight source BLi for the i-th display area, the gradation display can be continued by use of the light emitted from the backlight source BLi+1 without wasting any light in the interval. As a result, the contrast increased to 575. Furthermore, as to the moving-image viewability, it is possible to obtain an effect similar to that in a case where the duty ratio of the backlight BL is 50% and the black display is performed in a half of one frame. That is, the obtained moving-image viewability is not degraded as compared with the case where the black insertion ratio is set to 50%.

The contrast obtained at the conventional black insertion ratio of 20% is 500, and the contrast obtained at the black insertion ratio of 50% is 285. On the other hand, the predetermined periods T1, T2 are provided to set a relation of the black insertion ratio of 30% and the backlight duty ratio of 50% as in the present embodiment. Accordingly, the black insertion period is set to be shorter than the turn-off period of each of the backlight sources BL1 to BLk. In this case, it has been confirmed that the contrast is largely increased to 575 whereas it is possible to obtain substantially the same moving-image viewability as that at the black insertion ratio of 50%.

It is to be noted that the present invention is not limited to the above embodiment, and can variously be modified without departing from the scope.

In the above embodiment, there is used the relation of the black insertion ratio of 30% and the duty ratio of 50%, but this value can arbitrarily be changed for the optimization.

Moreover, in the above embodiment, there has been described the liquid crystal display device using a liquid crystal material whose alignment requires the black insertion driving, but the present invention is not limited to the black insertion driving, and is applicable to any liquid crystal display device in which the pixel voltage should be periodically fixed to a certain value regardless of the image gradation display. Therefore, the alignment mode of the liquid crystal material is not limited to the OCB. Furthermore, the pixel voltage may be fixed to the certain value by use of, for example, a frame period or the like next to the frame period when the image is displayed.

Furthermore, in the above embodiment, the backlight sources BL1 to BLk are individually driven by the inverters LD1 to LDk, respectively, but, for example, the inverters are reduced to a half, and may be controlled to drive the backlight sources BL1 to BLk every two adjacent sources. That is, it is possible to drive the backlight sources BL1 to BLk every predetermined number of adjacent backlight sources. The predetermined number of the adjacent backlight sources constituting the driving unit will hereinafter be referred to as one phase.

In addition, in the above embodiment, the lighting timing of each of the backlight sources BL1 to BLk is controlled to be delayed behind the gradation display period start timing of all of the liquid crystal pixels PX positioned in the corresponding display area. However, from a viewpoint that more satisfactory effect than ever be obtained, this control may be performed with respect to the lighting timing of at least one phase of the backlight sources BL1 to BLk, or with respect to the gradation display period start timing of the liquid crystal pixels PX of arbitrary rows positioned in the corresponding display area.

Moreover, in the above embodiment, a light-off timing of each of the backlight sources BL1 to BLk is controlled to advance ahead of the non-gradation display period start timing of all of the liquid crystal pixels PX positioned in the corresponding display area. However, from a viewpoint that more satisfactory effect than ever be obtained, this control may be performed with respect to the light-off timing of at least one phase of the backlight sources BL1 to BLk, or with respect to the non-gradation display period start timing of the liquid crystal pixels PX of arbitrary rows positioned in the corresponding display area.

Furthermore, in the above embodiment, the backlight sources BL1 to BLk are controlled to face the liquid crystal pixels PX, respectively, of the row positioned substantially in the center of the corresponding display area, and are controlled to turn on and turn off, respectively, on the basis of the operations of the liquid crystal pixels PX of the row positioned substantially in the center of each of the display areas. However, from a viewpoint that more satisfactory effect than ever be obtained, at least one phase of the backlight sources BL1 to BLk may face the liquid crystal pixels PX of the arbitrary rows in the corresponding display area, and this backlight source may be controlled to turn on and turn off on the basis of the operations of the liquid crystal pixels PX of the arbitrary rows in this display area.

In addition, in the above embodiment, each of the backlight sources BL1 to BLk is constituted of the cold-cathode fluorescent tube, but the present invention is also applicable to a case where an LED backlight in which light emitting diodes (LEDs), for example, are used as the backlight sources BL1 to BLk.

The present invention is applicable to a liquid crystal display device in which, for example, one frame period is divided into a gradation display period and a non-gradation display period and which performs variable gradation display in response to a video signal in the gradation display period and which performs a display of a fixed gradation such as black or an intermediate gradation in the non-gradation display period.

What is claimed is:

1. A liquid crystal display device comprising:
a display panel having a plurality of liquid crystal pixels;
an illuminative light source unit which illuminates the display panel;
a light source driving unit which turns on and off the illuminative light source unit at a predetermined duty ratio every frame period for update of the video signal; and
a panel driving unit which allows each of the liquid crystal pixels to hold a variable pixel voltage that depends on the video signal for a gradation display period longer than a turn-on period of the illuminative light source unit and to hold a fixed pixel voltage that does not depend on the video signal for a non-gradation display period shorter than a turn-off period of the illuminative light source unit.

2. The liquid crystal display device according to claim 1, wherein the liquid crystal pixels are arranged substantially in a matrix form in the display panel, and
the illuminative light source unit includes a plurality of light sources which successively illuminate a plurality of display areas each including rows of liquid crystal pixels.

3. The liquid crystal display device according to claim 2, wherein the light source driving unit is constituted to delay a lighting timing of at least one phase of the light sources behind a gradation display period start timing of arbitrary rows of liquid crystal pixels positioned in the corresponding display area.

4. The liquid crystal display device according to claim 2 or 3, wherein the light source driving unit is constituted to advance a light-off timing of at least one phase of the light sources ahead of a non-gradation display period start timing of the arbitrary rows of liquid crystal pixels positioned in the corresponding display area.

5. The liquid crystal display device according to claim 2, wherein at least one phase of the light sources faces the liquid crystal pixels of the arbitrary rows in the corresponding display area, and the light source driving unit is configured to turn on and turn off at least one phase of the light sources on the basis of operations of the liquid crystal pixels of the arbitrary rows in the corresponding display area.

6. The liquid crystal display device according to claim 2, wherein the panel driving unit generates a gradation display start signal and a non-gradation display start signal in the one frame period, sequentially drives the liquid crystal pixels in units of a predetermined number of rows by control of the gradation display start signal to allow the liquid crystal pixels of the driven rows to hold the variable pixel voltage, and simultaneously drives the liquid crystal pixels in units of a predetermined number of rows by control of the non-gradation display start signal to allow the liquid crystal pixels of the driven rows to hold the fixed pixel voltage.

7. The liquid crystal display device according to claim 3, wherein the light source driving unit includes a plurality of voltage conversion inverters which generate driving voltages of the light sources; and an inverter control circuit which detects at least the gradation display start signal to output a pulse width modulation signal having the predetermined duty ratio and which outputs the pulse width modulation signals to the voltage conversion inverters with phase differences corresponding to pitches of the light sources.

8. The liquid crystal display device according to claim 1, wherein the inverter control circuit is configured to raise the pulse width modulation signal upon elapse of a first period from the gradation display period start timing, and lower the signal upon elapse of a second period from the rise of the signal, the second period being shorter than the gradation display period.

9. The liquid crystal display device according to claim 1, wherein the liquid crystal pixels include liquid crystal molecules aligned in a bend alignment.

10. A method of controlling display of a liquid crystal display device including a display panel having a plurality of liquid crystal pixels, and an illuminative light source unit which illuminates the display panel, the method comprising:
turning on and off the illuminative light source unit at a predetermined duty ratio every frame period for update of a video signal; and
allowing each of the liquid crystal pixels to hold a variable pixel voltage that depends on the video signal for a gradation display period longer than a turn-on period of the illuminative light source unit and to hold a fixed pixel voltage that does not depend on the video signal for a non-gradation display period shorter than a turn-off period of the illuminative light source unit.

11. The display control method according to claim 10, wherein the liquid crystal pixels are arranged substantially in a matrix form in the display panel, and the illuminative light source unit includes a plurality of light sources which successively illuminate a plurality of display areas each including rows of liquid crystal pixels.

12. The display control method according to claim 11, further comprising:
delaying a lighting timing of at least one phase of the light sources behind a gradation display period start timing of arbitrary rows of liquid crystal pixels positioned in the corresponding display area.

13. The display control method according to claim 11 or 12, further comprising:
advancing a light-off timing of at least one phase of the light sources ahead of a non-gradation display period start timing of the arbitrary rows of liquid crystal pixels positioned in the corresponding display area.

14. The display control method according to claim 11, wherein at least one of the light sources faces the liquid crystal pixels of the arbitrary rows in the corresponding display area, and the at least one light source is turned on and turned off on the basis of operations of the liquid crystal pixels of the arbitrary rows in the corresponding display area.

15. The display control method according to claim 11, further comprising:
generating a gradation display start signal and a non-gradation display start signal in the one frame period;
sequentially driving the liquid crystal pixels in units of a predetermined number of rows by control of the gradation display start signal to allow the liquid crystal pixels of the driven rows to hold the variable pixel voltage; and
simultaneously driving the liquid crystal pixels in units of a predetermined number of rows by control of the non-gradation display start signal to allow the liquid crystal pixels of the driven rows to hold the fixed pixel voltage.

16. The display control method according to claim 12, further comprising:
detecting at least the gradation display start signal to generate a pulse width modulation signal having the predetermined duty ratio; and
outputting the pulse width modulation signals to a plurality of voltage conversion inverters with phase differences corresponding to pitches of the light sources.

17. The display control method according to claim 16, further comprising:
raising the pulse width modulation signal upon elapse of a first period from the gradation display period start timing; and
lowering the signal upon elapse of a second period from the rise of the signal, the second period being shorter than the gradation display period.

18. The display control method according to claim 10, wherein the liquid crystal pixels include liquid crystal molecules aligned in a bend alignment.

19. A liquid crystal display device comprising:
a display panel in which a plurality of liquid crystal pixels are arranged substantially in a matrix form and which sequentially drives the liquid crystal pixels in units of one row at a predetermined timing to hold in the liquid crystal pixels a variable pixel voltage as a write variable pixel voltage for gradation display and which further sequentially drives the liquid crystal pixels at a timing deviating from the predetermined timing to hold in the liquid crystal pixels a fixed pixel voltage as a write fixed pixel voltage for non-gradation display and which repeatedly performs this operation to perform display; and
phase light sources arranged substantially in parallel with the row of liquid crystal pixels,
the rows of liquid crystal pixels being divided into groups each of which is illuminated mainly with one of the phase light sources,
each group including at least two rows having different timings when the fixed pixel voltage is written for the non-gradation display, and at least two rows having different timings when the variable pixel voltage is written for the gradation display,
the light source turning off before the earliest timing to write the fixed pixel voltage for the non-gradation display in the group to which the light source belongs, the light source turning on after the latest timing to write the variable pixel voltage for the gradation display in the group to which the light source belongs.
